(19) United States
(12) Patent Application Publication
(10) Pub. No.: US 2015/0149474 A1
(43) Pub. Date: May 28, 2015

(54) METHOD AND APPARATUS FOR INDEXING AND SEARCHING DOCUMENTS

(71) Applicant: kCura Corporation, Chicago, IL (US)

(72) Inventors: Andrew Henry Sieja, Chicago, IL (US); Keith Loren Kaminski, Mount Prospect, IL (US)

(73) Assignee: kCura Corporation, Chicago, IL (US)

(21) Appl. No.: 14/091,581

(22) Filed: Nov. 27, 2013

(51) Int. Cl. G06F 17/30

(52) U.S. Cl. CPC G06F 17/30011; G06F 17/30312
USPC 707/741; 707/769

(57) ABSTRACT

Methods and apparatus for indexing and searching documents are disclosed. For example, a user of an electronic record management system may deploy a background indexing processes using a certain amount of parallel computing resources that may take several hours to complete. Subsequently, the user may change the number of computing resources dedicated to the indexing process without interrupting the indexing process. Upon completion, the indexing process creates a plurality of subindexes. The user may then deploy a background searching processes using a selected amount of parallel computing resources that may take several hours to complete. Subsequently, the user may change the number of computing resources dedicated to the searching process without interrupting the searching process. Upon completion, the searching process creates a plurality of partial search results that are combined into a final search result.

The present disclosure relates in general to databases, and, in particular, to methods and apparatus for indexing and searching documents.

### BACKGROUND

The vast majority of documents we create and/or archive are stored electronically. In order to quickly find certain documents, the relevant data from these documents is typically extracted, catalogued, and organized in a database to make them searchable. This process is more commonly known as building an index. In some circumstances, these databases can be very large. For example, a law suit may involve over a million documents. Searching these large databases can be problematic.

First, depending on the size of the document collection, the indexing process can take hours or even days. Once an index has been built, the next challenge is searching against it. Depending on the complexity of the search and the size of the document collection, a search might take anywhere from a few seconds to several hours to complete. For both building and searching an index, options for improving performance have been traditionally limited to hardware improvements. One can make upgrades to the servers responsible for building or searching the index, improve the connection between the server and the source documents, or improve the connection between the server and the index.

### BRIEF DESCRIPTION OF THE DRAWINGS

FIG. 1 is a block diagram of an example network communication system.

FIG. 2 is a block diagram of an example computing device.

FIG. 3 is a block diagram of example computing devices cooperating in a network communication system to build a search index for a collection of documents.

FIG. 4 is a flowchart of an example manager agent process.

FIG. 5 is a flowchart of an example worker agent process.

FIG. 6 is a flowchart of an example index building process.

FIG. 7 is a block diagram of example computing devices cooperating in a network communication system to search a collection of documents.

FIG. 8 is a flowchart of an example search provider process.

FIG. 9 is a flowchart of an example stored procedure process.

FIG. 10 is a block diagram of example computing devices cooperating in a network communication system to execute the example stored procedure process.

FIG. 11 is a flowchart of an example search agent process.

FIGS. 12-13 are a flowchart of an example indexing process.

FIGS. 14-15 are a flowchart of an example searching process.

### DETAILED DESCRIPTION OF THE PREFERRED EMBODIMENTS

Briefly, methods and apparatus for indexing and searching documents are disclosed. For example, a user of an electronic record management system may deploy a background indexing process using a certain amount of parallel computing resources that may take several hours to complete. Subsequently, the user may change the number of computing resources dedicated to the indexing process without interrupting the indexing process. Upon completion, the indexing process creates a plurality of subindexes. The user may then deploy a background searching process using a selected amount of parallel computing resources that may take several hours to complete. Subsequently, the user may change the number of computing resources dedicated to the searching process without interrupting the searching process. Upon completion, the searching process creates a plurality of partial search results that are combined into a final search result.

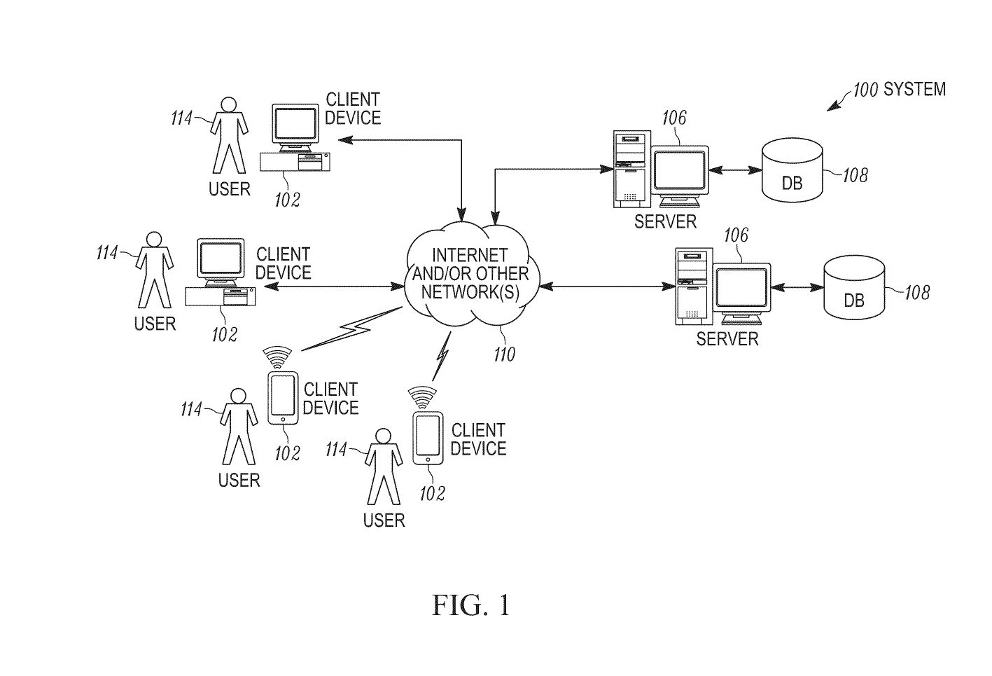

Turning now to the figures, the present system is most readily realized in a network communication system 100. A block diagram of certain elements of an example network communications system 100 is illustrated in FIG. 1. The illustrated system 100 includes one or more client devices 102 (e.g., computer, television, camera, phone), one or more web servers 106, and one or more databases 108. Each of these devices may communicate with each other via a connection to one or more communications channels 110 such as the Internet or some other wired and/or wireless data network, including, but not limited to, any suitable wide area network or local area network. It will be appreciated that any of the devices described herein may be directly connected to each other instead of over a network.

The web server 106 stores a plurality of files, programs, and/or web pages in one or more databases 108 for use by the client devices 102 as described in detail below. The database 108 may be connected directly to the web server 106 and/or via one or more network connections. The database 108 stores data as described in detail below.

One web server 106 may interact with a large number of client devices 102. Accordingly, each server 106 is typically a high end computer with a large storage capacity, one or more fast microprocessors, and one or more high speed network connections. Conversely, relative to a typical server 106, each client device 102 typically includes less storage capacity, a single microprocessor, and a single network connection.

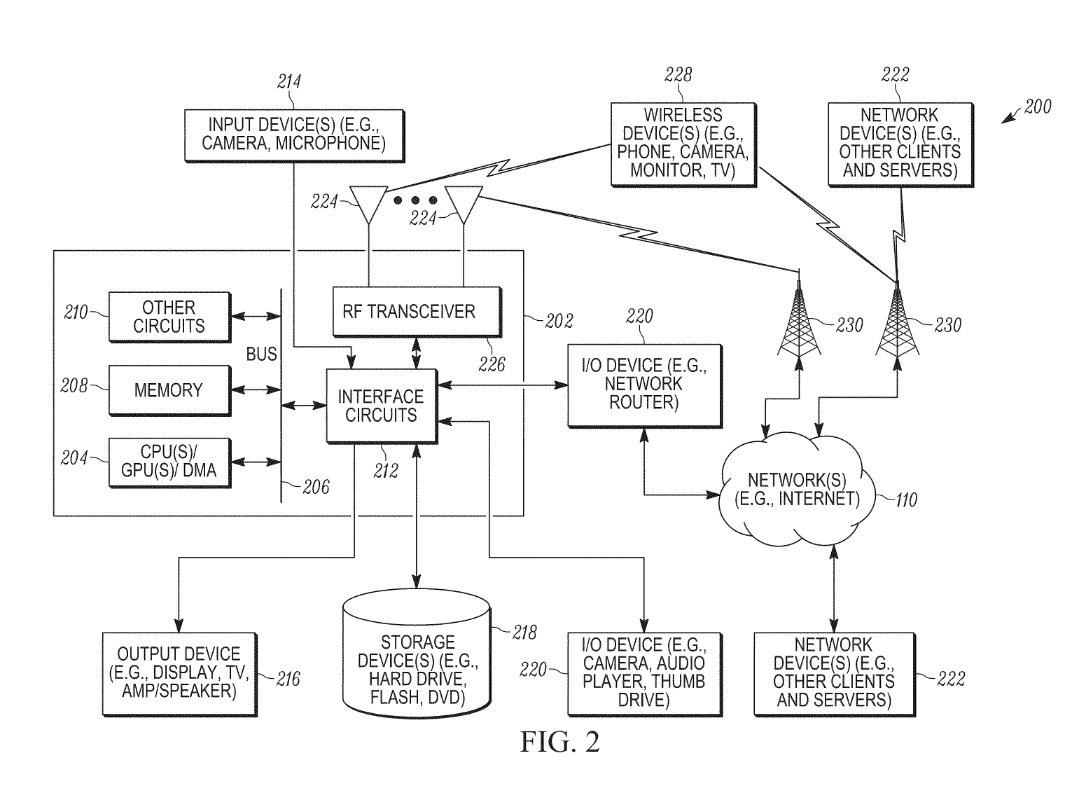

Each of the devices illustrated in FIG. 1 (e.g., client 102 and/or server 106) may include certain common aspects of many computing devices such as microprocessors, memories, direct memory access units, peripherals, etc. FIG. 2 is a block diagram of an example computing device.

The example computing device 200 includes a main unit 202 which may include, if desired, one or more processing units 204 electrically coupled by an address/data bus 206 to one or more memories 208, other computer circuitry 210, and one or more interface circuits 212. The processing unit 204 may include any suitable processor or plurality of processors. In addition, the processing unit 204 may include other components that support the one or more processors. For example, the processing unit 204 may include a central processing unit (CPU), a graphics processing unit (GPU), and/or a direct memory access (DMA) unit.

The memory 208 may include various types of non-transitory memory including volatile memory and/or non-volatile memory such as, but not limited to, distributed memory, read-only memory (ROM), random access memory (RAM) etc. The memory 208 typically stores a software program that interacts with the other devices in the system as described herein. This program may be executed by the processing unit 204 in any suitable manner. The memory 208 may also store digital data indicative of documents, files, programs, web pages, etc. retrieved from a server and/or loaded via an input device 214.

The interface circuit 212 may be implemented using any suitable interface standard, such as an Ethernet interface and/or a Universal Serial Bus (USB) interface. One or more input devices 214 may be connected to the interface circuit 212 for entering data and commands into the main unit 202. For example, the input device 214 may be a keyboard, mouse, touch screen, track pad, isopoint, camera, voice recognition system, accelerometer, global positioning system (GPS), and/or any other suitable input device.

One or more displays, printers, speakers, monitors, televisions, high definition televisions, and/or other suitable high bandwidth output devices 216 may also be connected to the main unit 202 via the interface circuit 212. High bandwidth output devices 216 typically consume uncompressed data, such as uncompressed audio and/or video data. For example, a display for displaying decompressed video data may be a cathode ray tube (CRTs), liquid crystal displays (LCDs), electronic ink (e-ink), and/or any other suitable type of display.

One or more storage devices 218 may also be connected to the main unit 202 via the interface circuit 212. For example, a hard drive, CD drive, DVD drive, and/or other storage devices may be connected to the main unit 202. The storage devices 218 may store any type of data used by the device 200.

The computing device 200 may also exchange data with one or more low bandwidth input/output (I/O) devices 220. Low bandwidth I/O devices 220 typical produce and/or consume compressed data, such as compressed audio and/or video data. For example, low bandwidth I/O devices 220 may include network routers, camera, audio players, thumb drives etc.

The computing device 200 may also exchange data with other network devices 222 via a connection to a network 110. The network connection may be any type of network connection, such as an Ethernet connection, digital subscriber line (DSL), telephone line, coaxial cable, wireless base station 230, etc. Users 114 of the system 100 may be required to register with a server 106. In such an instance, each user 114 may choose a user identifier (e.g., e-mail address) and a password which may be required for the activation of services. The user identifier and password may be passed across the network 110 using encryption built into the user's browser. Alternatively, the user identifier and/or password may be assigned by the server 106.

In some embodiments, the device 200 may be a wireless device 200. In such an instance, the device 200 may include one or more antennas 224 connected to one or more radio frequency (RF) transceivers 226. The transceiver 226 may include one or more receivers and one or more transmitters operating on the same and/or different frequencies. For example, the device 200 may include a blue tooth transceiver 216, a Wi-Fi transceiver 216, and diversity cellular transceivers 216. The transceiver 226 allows the device 200 to exchange signals, such as voice, video and any other suitable data, with other wireless devices 228, such as a phone, camera, monitor, television, and/or high definition television. For example, the device 200 may send and receive wireless telephone signals, text messages, audio signals and/or video signals directly and/or via a base station 230.

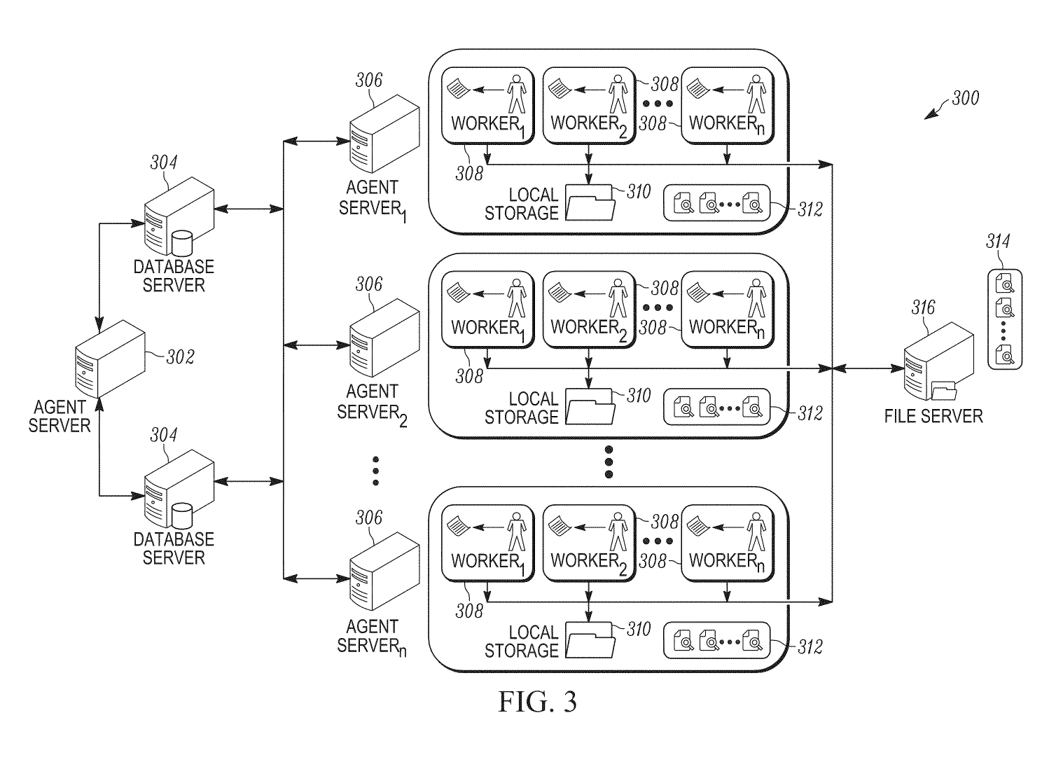

FIG. 3 is a block diagram of example computing devices cooperating in a network communication system 300 to build a search index for a collection of documents. In this example, an agent server 302 causes one or more database servers 304 to employ one or more additional agent servers 306 to divide the collection of documents into a plurality of subsets. One or more computing resources 308 (e.g., processor cores) on each agent server 306 indexes one of the subsets of documents using local storage 310 to create a subindex 312. If a computing resource 308 completes indexing one subset of the collection of documents, that computing resource 308 may be used to index another subset in the collection of documents and/or another subset of documents. Once all of the subsets of documents are indexed, the plurality of subindexes 312 may be combined into a master index 314 for that collection of documents and stored on a file server 316.

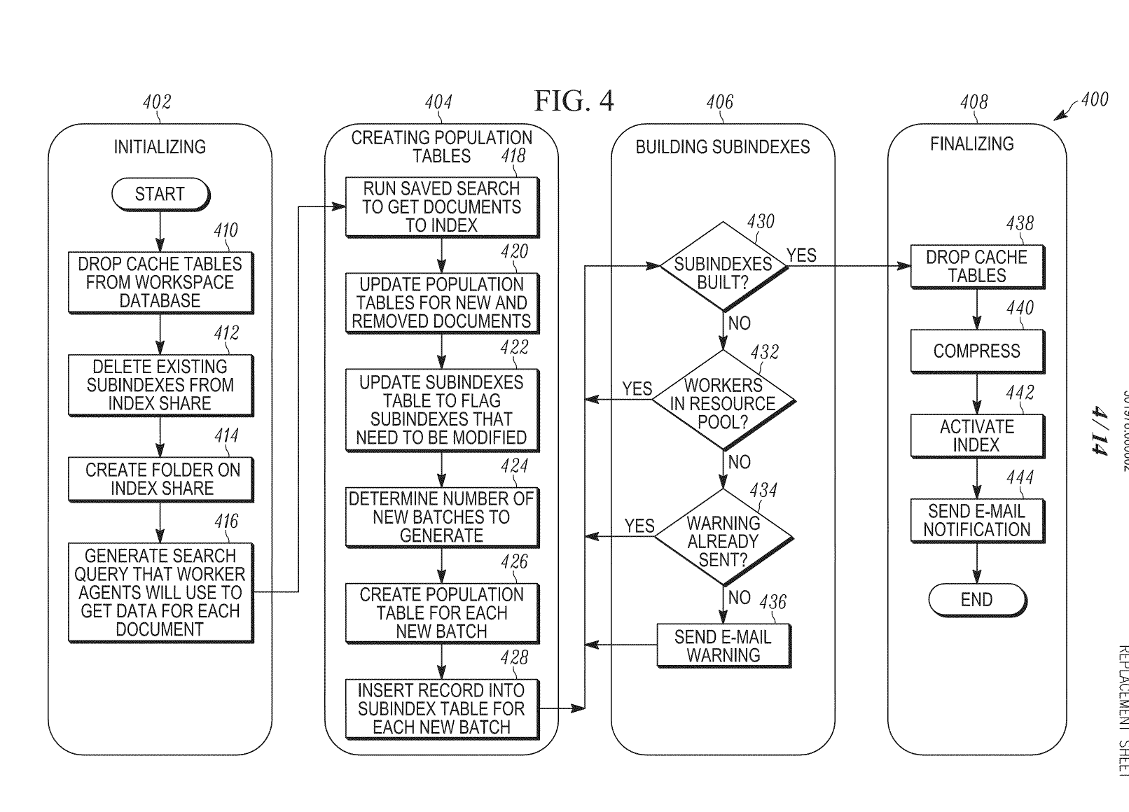

A flowchart of an example manager agent process 400 is illustrated in FIG. 4. The process 400 may be carried out by one or more suitably programmed processors, such as a CPU executing software (e.g., block 204 of FIG. 2). The process 400 may also be carried out by hardware or a combination of hardware and hardware executing software. Suitable hardware may include one or more application specific integrated circuits (ASICs), state machines, field programmable gate arrays (FPGAs), digital signal processors (DSPs), and/or other suitable hardware. Although the process 400 is described with reference to the flowchart illustrated in FIG. 4, it will be appreciated that many other methods of performing the acts associated with process 400 may be used. For example, the order of many of the operations may be changed, and some of the operations described may be optional.

The process 400 is divided into four phases including an initializing phase 402, a creating population tables phase 404, a building subindexes phase 406, and a finalizing phase 408. The process 400 begins in the initializing phase 402 when the manager agent drops cache tables from the workspace database (block 410). In addition, the manager agent deletes existing subindexes from the index share (block 412). Next, the manager agent creates a folder on the index share (block 414). Finally, the manager agent generates a database query (e.g., SQL stored procedure) that the worker agents may use to get data for each document (block 416).

Next, in the create population tables phase 404, the manager agent executes the database query to get documents to index (block 418). The manager agent then updates the population tables for new documents and removed documents (block 420). The manager agent also updates the subindex table to flag subindexes that need to be modified (block 422). Next, the manager agent determines the number of new batches to generate (block 424). The manager agent then creates a population table for each new batch (block 426). The manager agent then inserts each record into the subindex table for each new batch (block 428).

Next, during the building subindexes phase 406, the manager agent determines if the subindexes are already built (block 430). If the subindexes are not built, the manager agent determines if there are workers (e.g., computing resources) in the resource pool (block 432). If there are no workers in the resource pool, the manager agent determines if a warning message has already been sent (block 434). If a warning message has not already been sent, the manager agent sends a warning message (block 436). For example, the manager agent may send an email warning message. If there are workers in the resource pool, or the warning message has already been sent, the manager agent loops back to determine if the subindexes are built (block 430).

Once the subindexes are built, the finalizing phase 408 begins. First, the manager agent drops the cache tables (block 438). The manager agent then compresses (block 440) and activates (block 442) the indexes. Upon completion, the manager agent sends an email or other suitable notification (block 444).

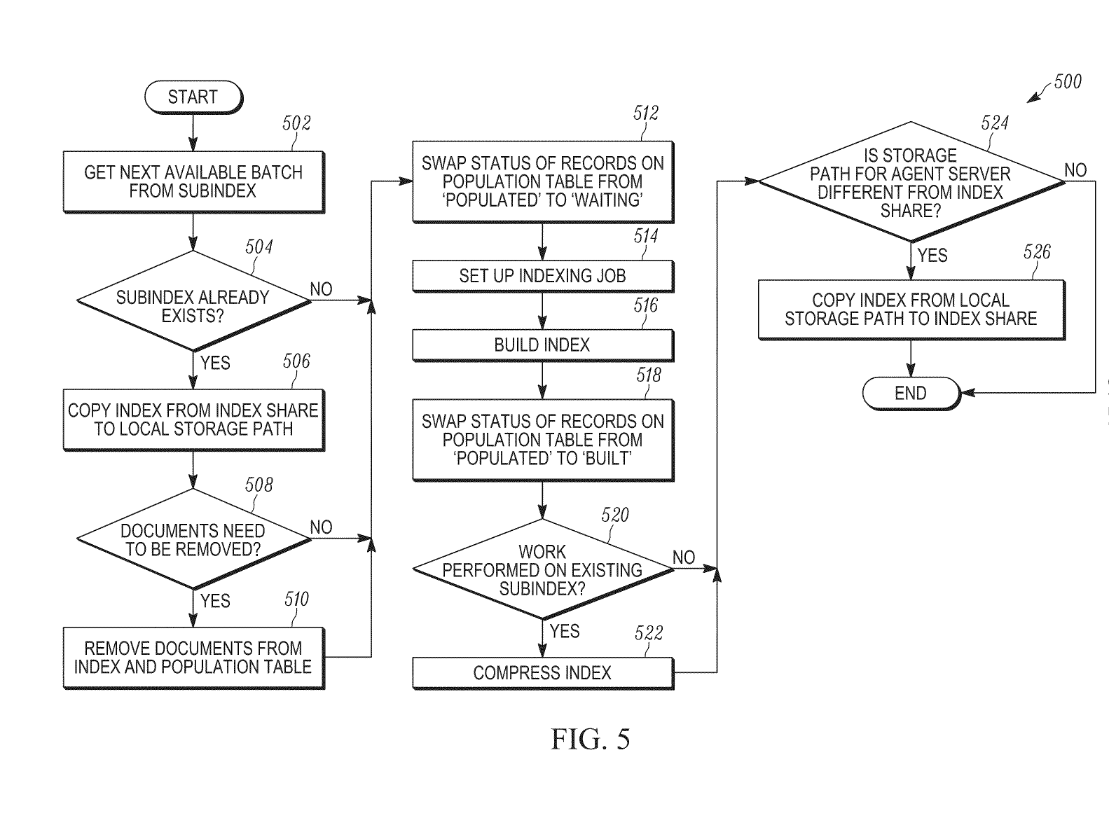

A flowchart of an example worker agent process 500 is illustrated in FIG. 5. The process 500 may be carried out by one or more suitably programmed processors, such as a CPU executing software (e.g., block 204 of FIG. 2). The process 500 may also be carried out by hardware or a combination of hardware and hardware executing software. Suitable hardware may include one or more application specific integrated circuits (ASICs), state machines, field programmable gate arrays (FPGAs), digital signal processors (DSPs), and/or other suitable hardware. Although the process 500 is described with reference to the flowchart illustrated in FIG. 5, it will be appreciated that many other methods of performing the acts associated with process 500 may be used. For example, the order of many of the operations may be changed, and some of the operations described may be optional.

In this example, the process 500 begins when a worker agent retrieves the next available batch from the subindex (block 502). The worker agent then determines if the subindex already exists (block 504). If the subindex already exists, the worker agent copies the index from the search index store to a local storage path (block 506). The worker agent then determines if there are documents that need to be removed (block 508). If there are documents that need to be removed, the worker agent removes the documents from the index in the population table (block 510).

Once the documents are removed from the index and the population table, or if there were no documents to be removed, or the subindex did not already exist, the worker agent changes the status of the records on the population table from a “populated” state to a “waiting” state (block 512). Next, the worker agent sets up the indexing job (block 514). The worker agent then builds the index (block 516) and changes the status of the records of the population table from a “populated” state to a “built” state (block 518). Next, the worker agent determines if there is work to be performed on an existing subindex (block 520). If there is work to be performed on an existing subindex, the worker agent compresses the index (block 522).

Once the index is compressed, or if there is no work to be performed on an existing sub index, the worker agent determines if the storage path for the agent server is different from the storage path for the index (block 524). If the storage path for the agent server is different than the storage path for the search index share, the worker agent copies the index from the local storage path to the index share (block 526). If the storage paths are not different, the worker agent does not need to copy the index from the local storage path to the index share.

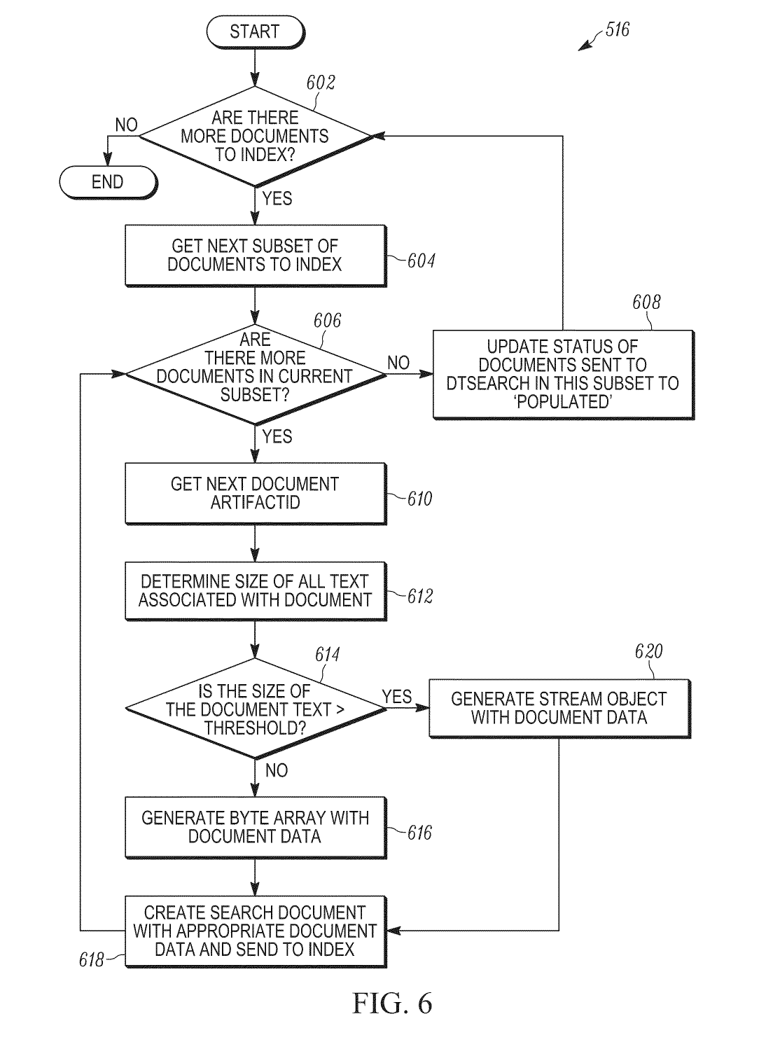

A flowchart of an example index building process 516 is illustrated in FIG. 6. The process 516 may be carried out by one or more suitably programmed processors, such as a CPU executing software (e.g., block 204 of FIG. 2). The process 516 may also be carried out by hardware or a combination of hardware and hardware executing software. Suitable hardware may include one or more application specific integrated circuits (ASICs), state machines, field programmable gate arrays (FPGAs), digital signal processors (DSPs), and/or other suitable hardware. Although the process 516 is described with reference to the flowchart illustrated in FIG. 6, it will be appreciated that many other methods of performing the acts associated with process 516 may be used. For example, the order of many of the operations may be changed, and some of the operations described may be optional.

In this example, the process 516 begins when one or more computing resources determine if there are more documents to index (block 602). If there are more documents to index, the computing resources retrieve the next subset of documents to index (block 604). The computing resources then determine if there are more documents in the current subset (block 606). If there are no more documents in the current subsets, the computing resources update the status of the documents in this subset to a state of “populated” (block 608). The computing resources then determine if there are more documents to index (block 602). If there are more documents in the current subset (block 606), the computing resources retrieve the next document artifact ID (block 610) and determines the size of the text associated with that document (block 612).

The computing resources then determine if the size of the document text is greater than a predetermined threshold (block 614). If the size of the document text is not greater than the predetermined threshold, the computing resources generate a byte array with the document data (block 616). The process then creates a search document with the appropriate document data and sends it to be indexed (block 618).

If the size of the document text is greater than the predetermined threshold (block 614), the computing resources generate a stream object with the document data (block 620). The process then creates a search document with the appropriate document data and sends it to be indexed (block 618), thereby bypassing the generation of the byte array with the document data (block 616).

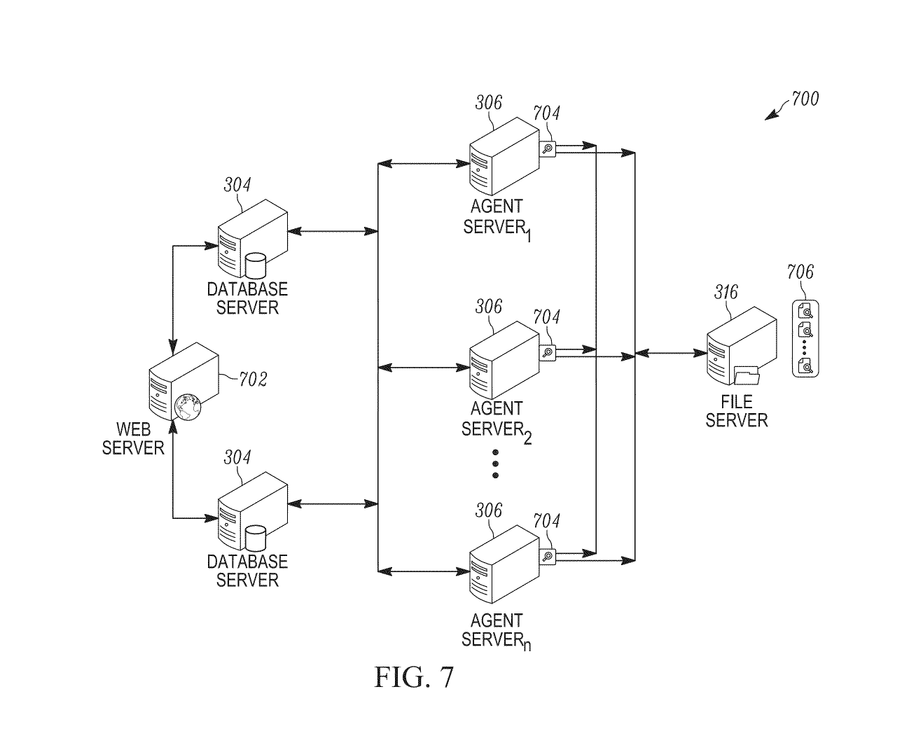

FIG. 7 is a block diagram of example computing devices cooperating in a network communication system to search a collection of documents. In this example, a web server 702 causes one or more database servers 304 to employ one or more agent servers 306 to use one or more computing resources (e.g., processor cores) on each agent server 306. Each agent server 306 searches a subindex 312 to create a partial search result 704. If a computing resource 308 completes searching one subindex 312, that computing resource 308 may be used to search another subindex 312. Once all of the subindexes 312 are searched, the plurality of partial search results 704 may be combined into a master search result 706 and stored on the file server 316.

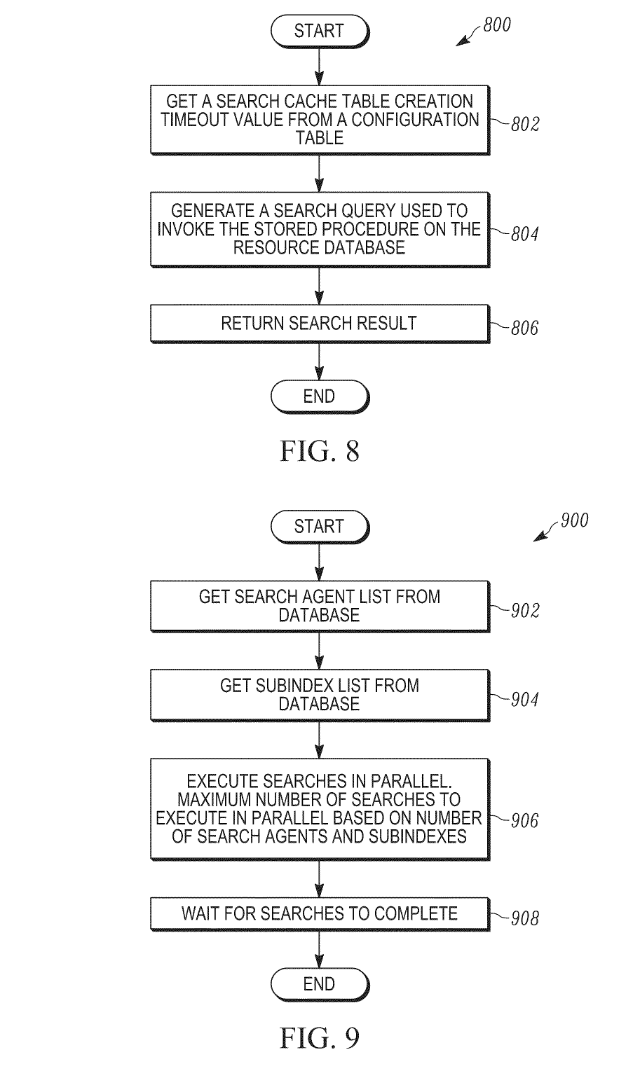

A flowchart of an example search provider process 800 is illustrated in FIG. 8. The process 800 may be carried out by one or more suitably programmed processors, such as a CPU executing software (e.g., block 204 of FIG. 2). The process 800 may also be carried out by hardware or a combination of hardware and hardware executing software. Suitable hardware may include one or more application specific integrated circuits (ASICs), state machines, field programmable gate arrays (FPGAs), digital signal processors (DSPs), and/or other suitable hardware. Although the process 800 is described with reference to the flowchart illustrated in FIG. 8, it will be appreciated that many other methods of performing the acts associated with process 800 may be used. For example, the order of many of the operations may be changed, and some of the operations described may be optional.

In this example, the process 800 begins when one or more computing resources retrieve a search cache table creation timeout value from a configuration table (block 802). The computing resources then generate a search query (e.g., SQL query) used to invoke the stored procedure on the resource database (block 804). Finally, the computing resources return the search result (block 806).

A flowchart of an example stored procedure process 900 is illustrated in FIG. 9. The process 900 may be carried out by one or more suitably programmed processors, such as a CPU executing software (e.g., block 204 of FIG. 2). The process 900 may also be carried out by hardware or a combination of hardware and hardware executing software. Suitable hardware may include one or more application specific integrated circuits (ASICs), state machines, field programmable gate arrays (FPGAs), digital signal processors (DSPs), and/or other suitable hardware. Although the process 900 is described with reference to the flowchart illustrated in FIG. 9, it will be appreciated that many other methods of performing the acts associated with process 900 may be used. For example, the order of many of the operations may be changed, and some of the operations described may be optional.

In this example, the process 900 begins when the stored procedure retrieves a search agent list from a database (block 902). The stored procedure then retrieves the subindex list from the database (block 904). The stored procedure then executes the searches in parallel with the maximum number of searches to execute in parallel being based on the number of search agents and subindexes (block 906). The stored procedure then waits for the searches to complete (block 908).

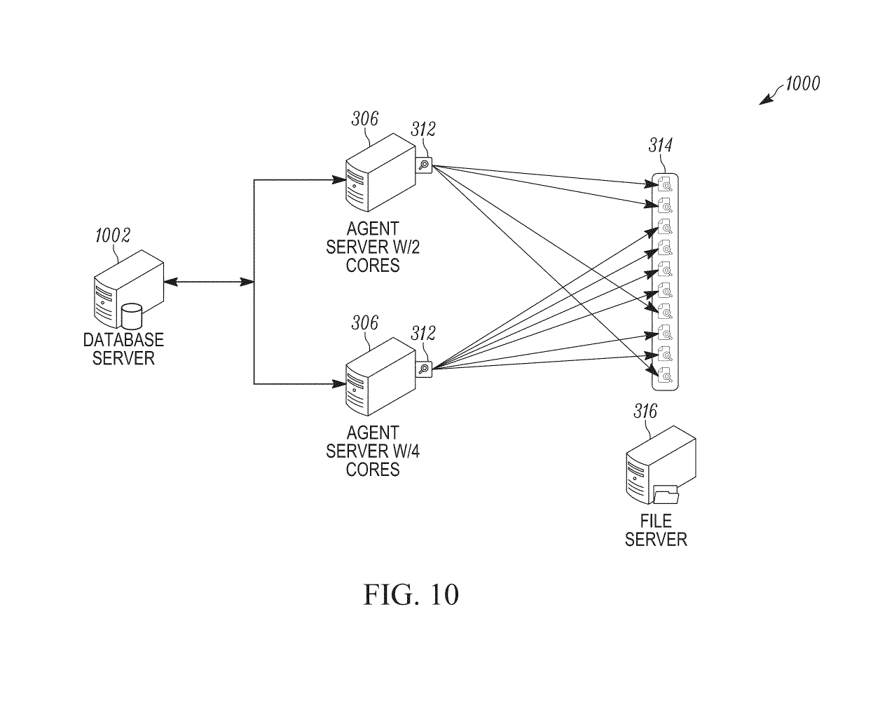

FIG. 10 is a block diagram of example computing devices cooperating in a network communication system to execute the example stored procedure process. In this example, a database server 1002 causes one or more agent servers 306 to use one or more computing resources (e.g., processor cores) on each agent server 306 to search a plurality of subindexes 314. Each agent server 306 searches a subindex 312 to create a partial search result. If a computing resource 308 completes searching one subindex 312, that computing resource 308 may be used to search another subindex 312. In this example, a first agent server 306 includes two processing cores, and a second agent server 306 includes four processing cores. As a result, the first agent server 306 searches four of the ten subindexes 312, and the second agent server 306 searches six of the ten subindexes 312. Once all of the subindexes 312 are searched, the plurality of partial search results may be combined into a master search result and stored on the file server 316.

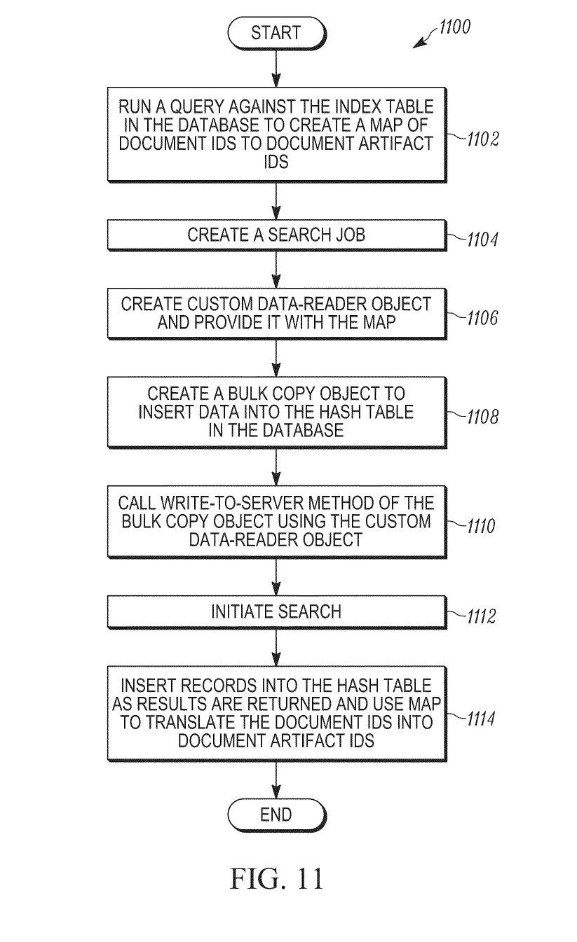

A flowchart of an example search agent process 1100 is illustrated in FIG. 11. The process 1100 may be carried out by one or more suitably programmed processors, such as a CPU executing software (e.g., block 204 of FIG. 2). The process 1100 may also be carried out by hardware or a combination of hardware and hardware executing software. Suitable hardware may include one or more application specific integrated circuits (ASICs), state machines, field programmable gate arrays (FPGAs), digital signal processors (DSPs), and/or other suitable hardware. Although the process 1100 is described with reference to the flowchart illustrated in FIG. 11, it will be appreciated that many other methods of performing the acts associated with process 1100 may be used. For example, the order of many of the operations may be changed, and some of the operations described may be optional.

In this example, the process 1100 begins when a search agent runs a query against the index table in the database to create a map that links document IDs to document artifact IDs (block 1102). The search agent then creates a search job (block 1104). The search agent then creates a custom data-reader object and provides it with the map (block 1106). The search agent then creates a bulk copy object to insert data into the hash table in the database (block 1108). The search agent then calls a write-to-server method of the bulk copy object using the custom data-reader object (block 1110), which initiates the search (block 1112). Finally, the bulk copy object inserts records into the hash table as results are returned and the map is used to translate the document IDs into document artifact IDs (block 1114).

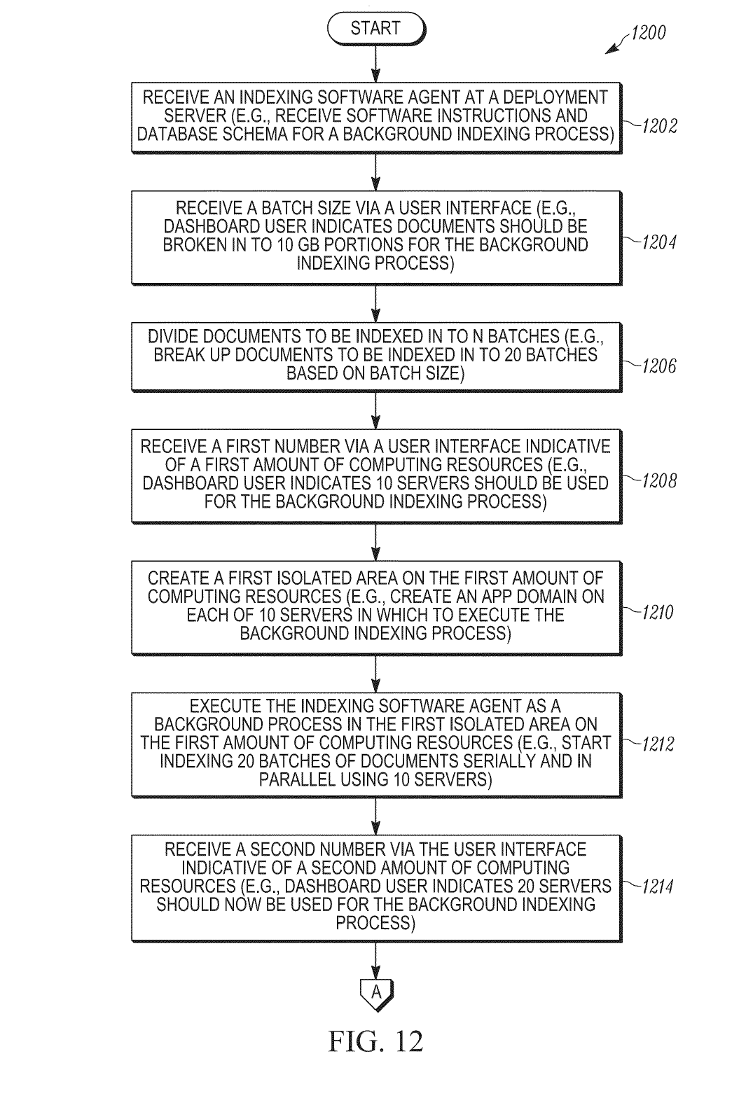

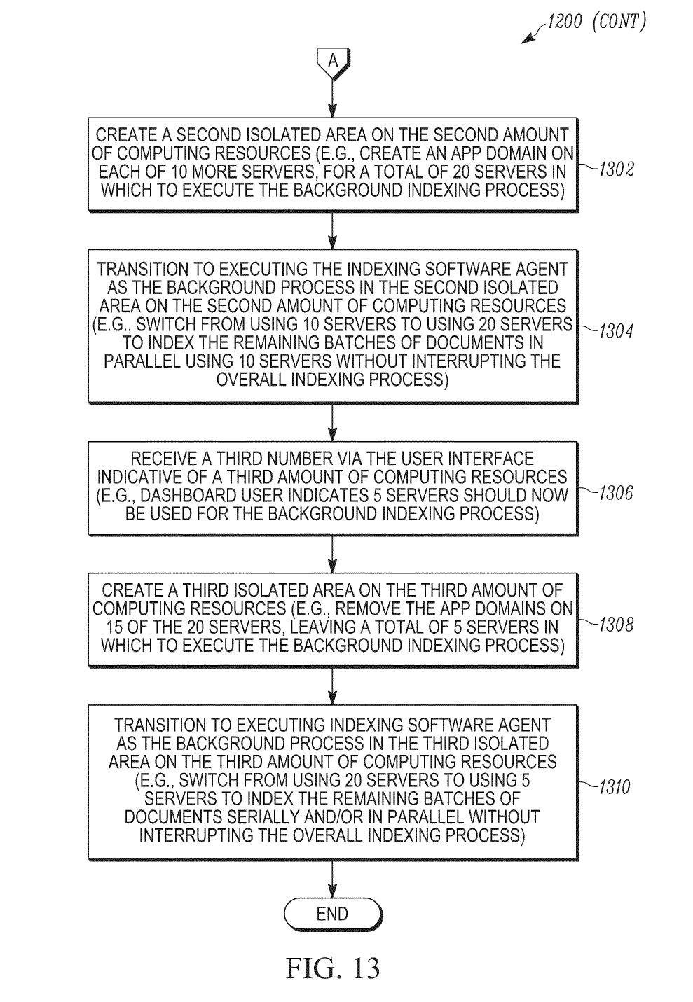

A flowchart of an example indexing process 1200 is illustrated in FIGS. 12-13. The process 1200 may be carried out by one or more suitably programmed processors, such as a CPU executing software (e.g., block 204 of FIG. 2). The process 1200 may also be carried out by hardware or a combination of hardware and hardware executing software. Suitable hardware may include one or more application specific integrated circuits (ASICs), state machines, field programmable gate arrays (FPGAs), digital signal processors (DSPs), and/or other suitable hardware. Although the process 1200 is described with reference to the flowchart illustrated in FIGS. 12-13, it will be appreciated that many other methods of performing the acts associated with process 1200 may be used. For example, the order of many of the operations may be changed, and some of the operations described may be optional.

In general, a user of an electronic record management system may deploy a background indexing processes using a certain amount of parallel computing resources that may take several hours to complete. Subsequently, the user may change the number of computing resources dedicated to the indexing process without interrupting the indexing process. Upon completion, the indexing process creates a plurality of subindexes.

More specifically, in this example, the process 1200 begins when a deployment server receives an indexing software agent (block 1202). For example, a server may receive software instructions and database schema for a background indexing process. The deployment server then receives a batch size via a user interface (block 1204). For example, a dashboard user may indicate that documents should be broken into 10 GB portions for the background indexing process. The deployment server then divides the documents to be indexed into N batches (block 1206). For example, a server may break up the documents to be indexed into 20 batches based on batch size.

The deployment server then receives a first number via a user interface indicative of a first amount of computing resources (block 1208). For example, the dashboard user may indicate that 10 servers should be used for the background indexing process. The deployment server then creates a first isolated area on the first amount of computing resources (block 1210). For example, an app domain may be created on each of 10 servers in which to execute the background indexing process. The deployment server then executes the indexing software agent as a background process in the first isolated area on the first amount of computing resources (block 1212). For example, the deployment server may start indexing 20 batches of documents serially and in parallel using 10 servers.

The deployment server then receives a second number via the user interface indicative of a second amount of computing resources (block 1214). For example, the dashboard user may indicate that 20 servers should now be used for the background indexing process. The deployment server then creates a second isolated area on the second amount of computing resources (block 1302). For example, an app domain may be created on each of 10 more servers, for a total of 20 servers in which to execute the background indexing process. The deployment server then transitions to executing the indexing software agent as the background process in the second isolated area on the second amount of computing resources (block 1304). For example, the deployment server may switch from using 10 servers to using 20 servers to index the remaining batches of documents in parallel using 10 servers without interrupting the overall indexing process.

The deployment server then receives a third number via the user interface indicative of a third amount of computing resources (block 1306). For example, the dashboard user may indicate that 5 servers should now be used for the background indexing process. The deployment server then creates a third isolated area on the third amount of computing resources (block 1308). For example, the deployment server may remove the app domains on 15 of the 20 servers, leaving a total of 5 servers in which to execute the background indexing process. The deployment server then transitions to executing an indexing software agent as the background process in the third isolated area on the third amount of computing resources (block 1310). For example, the deployment server may switch from using 20 servers to using 5 servers to index the remaining batches of documents serially and/or in parallel without interrupting the overall indexing process.

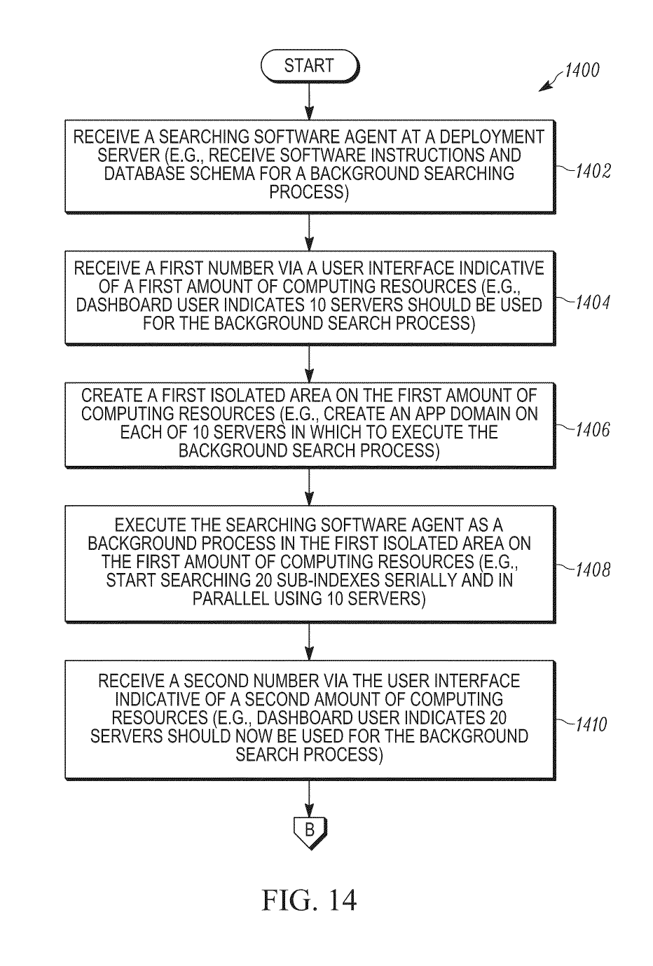

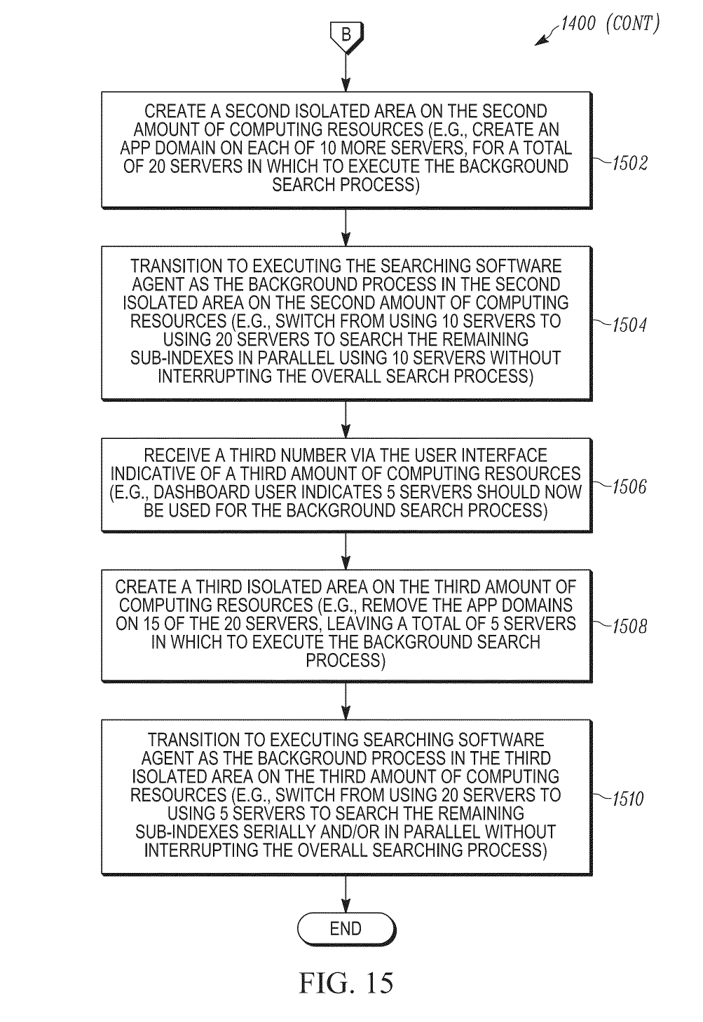

A flowchart of an example searching process 400 is illustrated in FIG. 1400. The process 1400 may be carried out by one or more suitably programmed processors, such as a CPU executing software (e.g., block 204 of FIG. 2). The process 1400 may also be carried out by hardware or a combination of hardware and hardware executing software. Suitable hardware may include one or more application specific integrated circuits (ASICs), state machines, field programmable gate arrays (FPGAs), digital signal processors (DSPs), and/or other suitable hardware. Although the process 1400 is described with reference to the flowchart illustrated in FIG. 14, it will be appreciated that many other methods of performing the acts associated with process 1400 may be used. For example, the order of many of the operations may be changed, and some of the operations described may be optional.

In general, a user may deploy a background searching process using a selected amount of parallel computing resources that may take several hours to complete. Subsequently, the user may change the number of computing resources dedicated to the searching process without interrupting the searching process. Upon completion, the searching process creates a plurality of partial search results that are combined into a final search result.

More specifically, in this example, the process 1400 begins when a deployment server receives a searching software agent (block 1402). For example, a server may receive software instructions and database schema for a background searching process. The deployment server then receives a first number via a user interface indicative of a first amount of computing resources (block 1404). For example, a dashboard user may indicate that 10 servers should be used for the background search process. The deployment server then creates a first isolated area on the first amount of computing resources (block 1406). For example, an app domain may be created on each of 10 servers in which to execute the background search process. The deployment server then executes the searching software agent as a background process in the first isolated area on the first amount of computing resources (block 1408). For example, the deployment server may start searching 20 sub-indexes serially and in parallel using 10 servers. The deployment server then receives a second number via the user interface indicative of a second amount of computing resources (block 1410). For example, the dashboard user may indicate that 20 servers should now be used for the background search process.

The deployment server then creates a second isolated area on the second amount of computing resources (block 1502). For example, an app domain may be created on each of 10 more servers, for a total of 20 servers in which to execute the background search process. The deployment server then transitions to executing the searching software agent as the background process in the second isolated area on the second amount of computing resources (block 1504). For example, the deployment server may switch from using 10 servers to using 20 servers to search the remaining sub-indexes in parallel using 10 servers without interrupting the overall search process. The deployment server then receives a third number via the user interface indicative of a third amount of computing resources (block 1506). For example, the dashboard user may indicate that 5 servers should now be used for the background search process. The deployment server then creates a third isolated area on the third amount of computing resources (block 1508). For example, the deployment server may remove the app domains on 15 of the 20 servers, leaving a total of 5 servers in which to execute the background search process. The deployment server then transitions to executing the searching software agent as the background process in the third isolated area on the third amount of computing resources (block 1510). For example, the deployment server may switch from using 20 servers to using 5 servers to search the remaining sub-indexes serially and/or in parallel without interrupting the overall searching process.

In summary, persons of ordinary skill in the art will readily appreciate that methods and apparatus for indexing and searching documents have been provided. Among other features, computing devices employing the disclosed system provide enhanced speed and flexibility when indexing and/or searching large collections of documents.

The foregoing description has been presented for the purposes of illustration and description. It is not intended to be exhaustive or to limit the invention to the exemplary embodiments disclosed. Many modifications and variations are possible in light of the above teachings. It is intended that the scope of the invention be limited not by this detailed description of examples, but rather by the claims appended hereto.

What is claimed is:

1. A method of indexing a collection of documents, the method comprising:
dividing the collection of documents into a plurality of N batches;
receiving a first number via a user interface indicative of a first amount of computing resources;
indexing the plurality of batches using the first amount of computing resources;
receiving a second number via the user interface indicative of a second amount of computing resources;
transitioning to indexing the plurality of batches using the second amount of computing resources; and
creating a plurality of subindexes of the plurality of batches.

2. The method of claim 1, further comprising receiving a third number via the user interface indicative of N.

3. The method of claim 1, wherein the first amount of computing resources is equal to N, and the plurality of batches are indexed in parallel.

4. The method of claim 1, wherein the first amount of computing resources is less than N, and the plurality of batches are indexed serially and in parallel.

5. The method of claim 1, wherein the first amount of computing resources is greater than N, the plurality of batches are indexed in parallel, and at least one of the computing resources is not used to index a batch in the plurality of batches.

6. The method of claim 1, wherein creating the plurality of subindexes produces an index for use in a legal document production process.

7. The method of claim 1, further comprising:
receiving an indexing software agent at a deployment server;
creating a first isolated area for executing the indexing software agent in the first amount of computing resources;
executing the indexing software agent as a first background process in the first isolated area on the first amount of computing resources;
creating a second isolated area for executing the indexing software agent in the second amount of computing resources; and
executing the indexing software agent as a second background process in the second isolated area on the second amount of computing resources.

8. The method of claim 1, wherein receiving the indexing software agent includes receiving software instructions and database schema.

9. The method of claim 1, wherein transitioning to indexing the plurality of batches using the second amount of computing resources does not interrupt indexing the collection of documents.

10. An apparatus for indexing a collection of documents, the apparatus comprising:
a processor;
a network interface operatively coupled to the processor; and
a memory device operatively coupled to the processor, the memory device storing instructions to cause the processor to:
divide the collection of documents into a plurality of N batches;
receive a first number via a user interface indicative of a first amount of computing resources;
index the plurality of batches using the first amount of computing resources;
receive a second number via the user interface indicative of a second amount of computing resources;
transition to indexing the plurality of batches using the second amount of computing resources; and
create a plurality of subindexes of the plurality of batches.

11. The apparatus of claim 10, wherein the instructions are structured to cause the processor to receive a third number via the user interface indicative of N.

12. The apparatus of claim 10, wherein the first amount of computing resources is equal to N, and the instructions are structured to cause the processor to have the plurality of batches indexed in parallel.

13. The apparatus of claim 10, wherein the first amount of computing resources is less than N, and the instructions are structured to cause the processor to have the plurality of batches indexed serially and in parallel.

14. The apparatus of claim 10, wherein the first amount of computing resources is greater than N, and the instructions are structured to cause the processor to have the plurality of batches indexed in parallel, wherein at least one of the computing resources is not used to index a batch in the plurality of batches.

15. The apparatus of claim 10, wherein creating the plurality of subindexes produces an index for use in a legal document production process.

16. The apparatus of claim 10, wherein the instructions are structured to cause the processor to:
receive an indexing software agent at a deployment server;
create a first isolated area for executing the indexing software agent in the first amount of computing resources;
execute the indexing software agent as a first background process in the first isolated area on the first amount of computing resources;
create a second isolated area for executing the indexing software agent in the second amount of computing resources; and
execute the indexing software agent as a second background process in the second isolated area on the second amount of computing resources.

17. The apparatus of claim 10, wherein the instructions are structured to cause the processor to receive the indexing software agent by receiving software instructions and database schema.

18. The apparatus of claim 10, wherein the instructions are structured to cause the processor to transition the indexing of the plurality of batches to the second amount of computing resources without interrupting the indexing of the collection of documents.

19. A non-transitory computer readable medium storing instructions structured to cause a computing device to:
divide the collection of documents into a plurality of N batches;
receive a first number via a user interface indicative of a first amount of computing resources;
index the plurality of batches using the first amount of computing resources;
receive a second number via the user interface indicative of a second amount of computing resources;
transition to indexing the plurality of batches using the second amount of computing resources; and
create a plurality of subindexes of the plurality of batches.

20. The computer readable medium of claim 19, wherein the instructions are structured to cause the processor to receive a third number via the user interface indicative of N.

21. The computer readable medium of claim 19, wherein the first amount of computing resources is equal to N, and the instructions are structured to cause the processor to have the plurality of batches indexed in parallel.

22. The computer readable medium of claim 19, wherein the first amount of computing resources is less than N, and the instructions are structured to cause the processor to have the plurality of batches indexed serially and in parallel.

23. The computer readable medium of claim 19, wherein the first amount of computing resources is greater than N, and the instructions are structured to cause the processor to have the plurality of batches indexed in parallel, wherein at least one of the computing resources is not used to index a batch in the plurality of batches.

24. The computer readable medium of claim 19, wherein creating the plurality of subindexes produces an index for use in a legal document production process.

25. The computer readable medium of claim 19, wherein the instructions are structured to cause the processor to:
receive an indexing software agent at a deployment server;
create a first isolated area for executing the indexing software agent in the first amount of computing resources;
execute the indexing software agent as a first background process in the first isolated area on the first amount of computing resources;
create a second isolated area for executing the indexing software agent in the second amount of computing resources; and
execute the indexing software agent as a second background process in the second isolated area on the second amount of computing resources.

26. The computer readable medium of claim 19, wherein the instructions are structured to cause the processor to receive the indexing software agent by receiving software instructions and database schema.

27. The computer readable medium of claim 19, wherein the instructions are structured to cause the processor to transition the indexing of the plurality of batches to the second amount of computing resources without interrupting the indexing of the collection of documents.

28. A method of searching a collection of documents, the method comprising:
dividing the collection of documents into a plurality of N batches;
receiving a first number via a user interface indicative of a first amount of computing resources;
searching the plurality of batches using the first amount of computing resources;
receiving a second number via the user interface indicative of a second amount of computing resources;
transitioning to searching the plurality of batches using the second amount of computing resources; and
creating a search result.

29. The method of claim 28, further comprising receiving a third number via the user interface indicative of N.

30. The method of claim 28, wherein the first amount of computing resources is equal to N, and the plurality of batches are searched in parallel.

31. The method of claim 28, wherein the first amount of computing resources is less than N, and the plurality of batches are searched serially and in parallel.

32. The method of claim 28, wherein the first amount of computing resources is greater than N, the plurality of batches are searched in parallel, and at least one of the computing resources is not used to search a batch in the plurality of batches.

33. The method of claim 28, wherein the search result is for use in a legal document production process.

34. The method of claim 28, further comprising:
receiving a searching software agent at a deployment server;
creating a first isolated area for executing the searching software agent in the first amount of computing resources;
executing the searching software agent as a first background process in the first isolated area on the first amount of computing resources;
creating a second isolated area for executing the searching software agent in the second amount of computing resources; and
executing the searching software agent as a second background process in the second isolated area on the second amount of computing resources.

35. The method of claim 28, wherein receiving the searching software agent includes receiving software instructions and database schema.

36. The method of claim 28, wherein transitioning to searching the plurality of batches using the second amount of computing resources does not interrupt searching the collection of documents.

37. An apparatus for searching a collection of documents, the apparatus comprising:
a processor;
a network interface operatively coupled to the processor; and
a memory device operatively coupled to the processor, the memory device storing instructions to cause the processor to:
divide the collection of documents into a plurality of N batches;
receive a first number via a user interface indicative of a first amount of computing resources;
search the plurality of batches using the first amount of computing resources;
receive a second number via the user interface indicative of a second amount of computing resources;
transition to searching the plurality of batches using the second amount of computing resources; and
create a search result.

38. The apparatus of claim 37, wherein the instructions are structured to cause the processor to receive a third number via the user interface indicative of N.

39. The apparatus of claim 37, wherein the first amount of computing resources is equal to N, and the instructions are structured to cause the processor to have the plurality of batches searched in parallel.

40. The apparatus of claim 37, wherein the first amount of computing resources is less than N, and the instructions are structured to cause the processor to have the plurality of batches searched serially and in parallel.

41. The apparatus of claim 37, wherein the first amount of computing resources is greater than N, and the instructions are structured to cause the processor to have the plurality of batches searched in parallel, wherein at least one of the computing resources is not used to search a batch in the plurality of batches.

42. The apparatus of claim 37, wherein the search result is for use in a legal document production process.

43. The apparatus of claim 37, wherein the instructions are structured to cause the processor to:
receive a searching software agent at a deployment server;
create a first isolated area for executing the searching software agent in the first amount of computing resources;
execute the searching software agent as a first background process in the first isolated area on the first amount of computing resources;
create a second isolated area for executing the searching software agent in the second amount of computing resources; and
execute the searching software agent as a second background process in the second isolated area on the second amount of computing resources.

44. The apparatus of claim 37, wherein the instructions are structured to cause the processor to receive the searching software agent by receiving software instructions and database schema.

45. The apparatus of claim 37, wherein the instructions are structured to cause the processor to transition the searching of the plurality of batches to the second amount of computing resources without interrupting searching the collection of documents.

46. A non-transitory computer readable medium storing instructions structured to cause a computing device to:
divide the collection of documents into a plurality of N batches;
receive a first number via a user interface indicative of a first amount of computing resources;
search the plurality of batches using the first amount of computing resources;
receive a second number via the user interface indicative of a second amount of computing resources;
transition to searching the plurality of batches using the second amount of computing resources; and
create a search result.

47. The computer readable medium of claim 46, wherein the instructions are structured to cause the processor to receive a third number via the user interface indicative of N.

48. The computer readable medium of claim 46, wherein the first amount of computing resources is equal to N, and the instructions are structured to cause the processor to have the plurality of batches searched in parallel.

49. The computer readable medium of claim 46, wherein the first amount of computing resources is less than N, and the instructions are structured to cause the processor to have the plurality of batches searched serially and in parallel.

50. The computer readable medium of claim 46, wherein the first amount of computing resources is greater than N, and the instructions are structured to cause the processor to have the plurality of batches searched in parallel, wherein at least one of the computing resources is not used to search a batch in the plurality of batches.

51. The computer readable medium of claim 46, wherein the search result is for use in a legal document production process.

52. The computer readable medium of claim 46, wherein the instructions are structured to cause the processor to:
receive a searching software agent at a deployment server;
create a first isolated area for executing the searching software agent in the first amount of computing resources;
execute the searching software agent as a first background process in the first isolated area on the first amount of computing resources;
create a second isolated area for executing the searching software agent in the second amount of computing resources; and
execute the searching software agent as a second background process in the second isolated area on the second amount of computing resources.

53. The computer readable medium of claim 46, wherein the instructions are structured to cause the processor to receive the searching software agent by receiving software instructions and database schema.

54. The computer readable medium of claim 46, wherein the instructions are structured to cause the processor to transition the searching of the plurality of batches to the second amount of computing resources without interrupting searching the collection of documents.
